(19) United States
(12) Patent Application Publication
(10) Pub. No.: US 2010/0209683 A1
(43) Pub. Date: Aug. 19, 2010

(54) MULTILAYERED FABRIC STRUCTURE FOR THE PRODUCTION OF COMPOSITE MATERIALS

(75) Inventors: Gerard Scheubel, Quebec (CA); Alex Alexis, Saint Georges (CA); Jacques Chasse, Sainte-marie de beauce (CA)

Correspondence Address: MERCHANT & GOULD PC, P.O. BOX 2903, MINNEAPOLIS, MN, 55402-0903, US

(73) Assignee: Texel, a division of ADS INC>, St. Elzear (CA)

(21) Appl. No.: 12/376,935

(22) PCT Filed: Aug. 8, 2007
(86) PCT No.: PCT/CA07/01390

§ 371 Date: Apr. 20, 2010

(30) Foreign Application Priority Data
Aug. 9, 2006 (CA) 2556145

(51) Int. Cl. B32B 5/06; B29C 51/42

(52) U.S. Cl. 428/219; 156/245; 156/148

(57) ABSTRACT

The invention relates to a fibrous structure comprising at least one mat of discontinuous thermoplastic fibers partially bound together, wherein said fibers can be dyed and are transferred to one or more backup fabric structures so as to create a resistant binding between the layers while maintaining a continuous felt-like surface appearance of the assembly thus obtained. This structure can produce in a continuous manner. Upon the application of appropriate pressure and temperature, the structure provides composite materials that do not require any additional surface-finishing process.

The present invention relates to a structure that permits to manufacture composite materials without having the necessity to use complex finishing treatments. Generally, when composite parts are manufactured by thermoforming fabrics which have thermoplastic or thermosetting properties, the parts that are obtained after cooling, keep a mark due to the pattern of the fabric.

Different finishing methods have been developed in order to overcome these difficulties and make it sure that the aspect of the pieces or panels that are so manufactured be aesthetic.

Thus, one may add an epoxy or polyester gel-coat according to methods known in the industry. However, this operation is complicated since the gel-coat must be at an advanced level of polymerisation to avoid marks due to the fabric across the gel-coat. Moreover, a fusible film must be interposed between the fabric and the gel-coat to increase the adhesion of gel-coat onto the fabric.

In another way, one may also use paint, but doing so requests an important preparation of the surface to be painted. In the presence of molding agents, one must clean and buff the composite before application of the paint. The paint will better adhere if the surface is treated by chemical methods such as flaming, corona treatment or application of an adherence primer. Thereafter, the paint may be applied. These operations are touchy and the steps of application and polymerisation of the finish or paint request energy and last almost 30 minutes each.

To overcome this inconvenience, interface thermoplastic films or glues have been developed for binding color dyed films onto the composite. However, the obtained results are variable and, depending on the thickness of the film, the mark of the tissue may be visible.

Plastic films have been extruded onto composites, but, in this case, they have been some limitation in width and such a method can be applied only to products in the form of panels.

In international laid-open application No. WO2004/062893, PARDO et al. disclose a method which consists in applying a thermoplastic or thermo-set color dyed powder in important quantity onto the surface of a substrate, both composites being heated together and calendered in order to obtain rigid sheets after cooling. If this method permits to resolve in part the above problem, it is limited to the manufacture of rigid plates by the use of a very specific equipment. For instance, it does not permit to manufacture pieces of non-planar shapes.

The object of the present invention is to provide an economical and industrially convenient answer to the problems raised by the application on a coating onto the surface of fabrics in order to give them durability and aesthetic while simplifying the method of manufacture of these composites.

More specifically, the object of the invention as broadly disclosed is a multilayered fibrous structure comprising at least one mat of discontinued fibers of thermoplastic nature partially bound together, which are transferred through one or more base fabric structures in order to create a resistant bond between the layers while maintaining a continuous felt-like surface appearance of the assembly that is thus obtained.

Another object of the invention as broadly disclosed is also a method for making this fibrous structure, which comprises the following steps.
A mat of continuous or discontinuous fibers of thermoplastic nature and different colors is positioned onto one or more substrates of textile nature which are in the form of a woven, knitted or non-woven fabric made of continuous or discontinuous fibers with a thermoplastic or thermo-set component and a reinforcement component.
These layers formed by the mat of fibers and the substrates are bound to each other by transferring the fibers of the mat through the substrate(s) below by way of a mechanical connection, such as needle punching.
The multilayered textile structure that is so obtained is soft and can be cut into parts of different shapes or used in the form of rolls.
The multilayered textile structure is then submitted to heating and pressure in suitable equipment for a determined period of time to ensure melting of the thermoplastic components of the composite.
After cooling, the composite has the requested shape and rigidity and the melted surface layer has a smooth aspect and uniform color.

The invention as claimed is however more specifically directed to a method for the manufacture of a rigid composite material having at least one continuous surface that is smooth, characterized in that it comprises the following steps:
binding a mat of thermoplastic fibers to a substrate made of a mixture of thermo-fusible fibers and other fibers that do no react at the same fusion temperature as the thermo-fusible fibers of the mixture, in order to form a multilayered structure; and
subjecting the multilayered structure that is so formed, to a cycle of heating and compression while putting the mat of thermoplastic fibers of the structure in contact with a continuous and smooth heating surface that is part of a heating system in order to form said rigid composite having at least one continuous surface that is smooth.

The mat of fibers which constitute the thermoplastic face of the multilayered structure is manufactured at a suitable basis weight by carding thermoplastic fibers of suitable size to permit to obtain a good visual covering of the underlined textile.

The thermoplastic polymers constituting the fibers can be selected from the group consisting of polypropylenes, polyesters and co-polyesters, polyamides, polyethylene, polyvinyl chloride, polyphenylene sulfide, and sheath core type, and any other materials that can be extruded, without limitation to the mentioned polymers. The fibers can also be made of polymers of non-identical nature, in the form of side to side, sheath core or island in the sea types. Usually, use is made of fibers constituted of polymers of different fusing points.

The size of the fibers constituting the material may vary from 0.9 to 25 dtex, more particularly between 1.2 and 8 dtex, the number of fibers per surface unit of given weight increasing if the size of the fibers is reduced. Accordingly, use will preferably be made with fibers as thin as possible to obtain the best possible covering ratio.

The weight of fibers per surface unit, also called basis weight, which is expressed in grams per square meter (g/mc²), may vary from 30 g/mc² to 1000 g/mc², more particularly between 200 and 500 g/mc². In this way, the higher is the basic weight of the mat, the better will be the covering ratio and the aspect of the final composite material. It is possible that the mat be made of fibers of different polymeric natures, sizes and colors.

The fibers may comprise additives such as anti-ultraviolet agents, dyeing pigments, antioxidants depending on the use of the final product.

The mat of fibers is made according to the methods known in the industry for the manufacture of non-woven material. One of these methods consists in opening bales of fibers and carding these fibers through a device for carding synthetic fibers in order to make uniform fiber web that are superposed by means of a cross lapping device which permit to obtain the requested basis weight. This cloth is pre-consolidated by means of needles in a needling equipment. The level of pre-consolidation is low to keep an important number of free fibers for the subsequent combination with the substrates of the composite.

The mat of fibers is moved in front of a second needling zone in which the fibers of the mat are inserted into the substrate by means of barbs of needles that pass through all the textile layers. This operation permits, on the one hand, to transfer part of the thermoplastic fibers into the substrate where such a part will participate to the consolidation of the fabric during heating and, on the other hand, to compress the surface of the mat to make it a layer that is coherent and very strongly bound to the substrate.

The consolidation degree that is requested can be obtained by varying the penetration of the needles into the substrate or also the number of perforations into this substrate. The penetration of the needles mainly determines the depth at which the fibers carried by the barbs of the needles may be moved. So, such a penetration will have to be more important if one wants to connect together several layers of substrate, whatever they are woven, knitted or nonwoven fabrics. The number of perforations per surface unit permits to increase the number of links between the non melting part of the mat and the one or more substrates. So, the number of thermoplastic fibers transported by the barbs of the needles into the substrates increases proportionally to the rate of perforation that is being used, which comparatively to all the methods of binding used so far such as application of powder or film, has a major advantage for increasing the cohesion of the composite.

After needling, the obtained multilayered textile can be converted as a conventional soft textile material, either into the form of a roll cut at a requested width of work, cut in sheets or in pieces of different formats.

The substrates may vary according to the intended use of the composite. They can be in the form of woven, knitted fabrics, continuous or discontinuous fibers intermixed or formed according to different structures by means of conventional textile methods. Usually the substrates are intended to insure reinforcement of the composite for a large part and can therefore be made, for example, of glass, poly-aramid, polyamide or carbon filaments. Likely, the fibers of the fiber mat that can be of different nature, the reinforcing fibers can also be made of this nature and thermoplastic fibers can also be mixed with non-thermoplastic fibers. In this case, the thermoplastic materials are identical to those that have been described for the composition of the mat to be needled in the substrate. Products such as Twintex® are good examples of structures representative of fabrics made of comingled fibers.

The substrate can also contain thermo-set materials such as polyvinyl ester, phenol resins, unsaturated polyester or epoxy, generally in the form of “prepregs” or pre-impregnated materials, and can receive the mat of thermoplastic fibers by needling.

The multilayered products obtained by combination of the mat with one or more of the substrates mentioned above can be transformed into a composite material. Numerous methods of manufacture can be used for advantageously benefiting from the present invention.

Vacuum molding can be used for parts of great dimension. The mold can be made of a composite material especially from epoxy resins or aluminum, and can be either external or internal. The mold is positioned into an oven or autoclave and a vacuum pump is used to permit to give the requested forms to the multilayered product. The whole is submitted to a temperature ranging from 100 to 300 degrees Celsius, preferably between 150 to 250 degrees Celsius. Use is made of a heating cycle that can range from 20 to 120 minutes according to the size of the piece, the nature of the material used for the mold and the thickness of the multilayer. It is important that the temperature be homogeneous in the fabric in order to realize an adequate consolidation of the composite, an elimination of air from the structure of the composite and to create a mat having a surface with a uniform and continuous skin external to the formed composite. This technique is applied to the manufacture of canoes, boats or parts of bodywork.

Thermoforming distinguishes from molding under vacuum in that the piece to be molded is heated at the requested temperature to achieve forming with heating apparatuses that can be removed when this temperature is obtained. If the surface mat is made of polypropylene, the temperature of the mat must be higher than 175° degrees. The mold is then positioned in contact with the material to be formed which is covered with an airtight membrane and vacuum is applied under the mold so that the material conforms with the mold. The thermoforming is thus made by vacuum pressure and/or by mechanical reinforcement. When the piece is cooled at a sufficient temperature, it is removed from the mold and the excess parts of it are cut.

The continuous manufacture of the composite can be achieved by heating and compression. The multilayered product assembled by needling is positioned between 2 belts of a press which can be made either in steel, manufactured for example by Sandvick or between 2 belts of a glass or aramid fabric covered with a fluorocarbon treated surface, available from Meyer. In all the cases, the equipments have a heating zone, a compression device and a cooling zone. The preheating of the mat of thermo-fusible fibers by means of an infrared system may help in increasing the speed of the method. According to the construction of equipment, one may apply a more or less pressure in the compression zone and thus realizes a calibration of a thickness of the composite. After cooling, the obtained composite can be cut into sheets with saws or with pressure water jet cutting systems.

The following examples illustrate several products obtained with this structure.

### EXAMPLE 1

A multilayered product is manufactured by combining a mat of polypropylene of 200 g/mc² made of fibers having a size of 3 deniers and a length of 75 mm, made of green color and pre-needled with needled barbs to obtain 36 to 60 perforations per square meter at a depth of 11 mm with a serge fabric 2×2 of 745 g/mc² manufactured from comingled fibers of 1870 tex containing 60% by weight of glass and 40% by weight of polypropylene of black color of 1.5 m width sold by Saint Gobain Vétrotex under the trademark Twintex®. The mat of polypropylene is needled into the Twintex® with 60 perforations per square meter at a depth of 9 mm. The multilayered complex that is obtained is positioned onto a mold with a smooth surface of aluminum on the side of the mat of dyed polypropylene fibers, said surface having the shape of a helmet, in combination with another layer of Twintex®. After closing of the mold, heating in an oven for 30 minutes at 205 degrees Celsius and cooling, the composite is unmolded. After unmolding, the helmet has a smooth and uniform skin of melted fibers having an aspect showing alternatively uniform green and black zones. This aspect was the one requested by the manufacture of the helmet.

### EXAMPLE 2

The same conditions as in example 1 were used, by replacing the polypropylene fibers of the mat of a weight of 400 g/mc² by a blend of polyester and co-polyester of sheath core type having a size of 2 deniers and a length of 51 mm length. The mold used was in the form of an aluminum plate of 50 cm×50 cm dimensions. After unmolding, the side of the mat is smooth and uniform and the black color of the polypropylene fibers of Twintex® do not appear through the melted surface mat.

### EXAMPLE 3

A multilayered system is made by manufacturing a mat of polypropylene of green color of the same composition as in Example 1. This mat is needled through another mat of short fibers of 200 g/mc² made of Kevlar® of 2.2 deniers and a length of 51 mm and simultaneously a Twintex® of white color having the same characteristics as the product disclosed in Example 1, except the color. The operating conditions are identical to those of Example 1 except for the depth of penetration which is 11 mm for transferring the polypropylene fibers through the layer of Kevlar® and the one of Twintex®. This multilayered complex is molded by thermoforming by using the following cycle: heating of the multilayered complex at 180 degrees Celsius for 40 seconds, application of a pressure under vacuum under the mold in the form of a helmet for 40 seconds, unmolding when the temperature reaches 50 degrees Celsius. The manufactured helmet has requested resistance to the impact, and a uniform and smooth green surface without marks from the fabric.

### EXAMPLE 4

A multilayered complex is built by manufacturing a mat of polyester-co polyester fibers according to the conditions of Example 2. The mat is needled through a fabric of 270 g/mc² made of continuous filaments of 1100 deniers of Kevlar® and through the mat of fibers of Nomex® of 300 g/mc² according to the needling conditions of Example 3. The complex is passed through two transporting belts of layer of glass recovered of Teflon® having a width of 50 cm at a speed of 3 meters per minute and through a heating zone of 1 linear meter raised at 215 degrees Celsius. The composite is then pressed between 2 cylinders under pressure of 10 N/m and passes through a cooling zone. The obtained composite has a thickness of 2 mm.

### EXAMPLE 5

A multilayered structure is made of layers made of fibers of polyester-copolymer according to Example 2. This mat is combined to a glass fabric of 270 g/mc² pre-impregnated with a pre-polymerized polyester vinyl resin at a ratio of 100 g/mc². The needling conditions of the mat in the pre-impregnated fabric are those of Example 1. The multilayered complex is moved into a vacuum mold located in a drying oven and submitted for 15 minutes at a temperature of 190 degrees Celsius. After cooling, the composite of 1.5 mm is unmolded and has a smooth surface and uniform color with a rigidity as it was expected.

1. A method for the manufacture of a rigid composite material having at least one continuous surface that is smooth, comprising the following steps:
binding a mat of thermoplastic fibers to a substrate made of a mixture of thermo-fusible fibers and other fibers that do not react at the same melting temperature as the thermo-fusible fibers of the mixture, in order to form a multilayered structure; and
subjecting the multilayered structure that is so formed, to a cycle of heating and compression while bringing the mat of thermoplastic fibers of the structure in contact with a continuous and smooth heating surface that is part of a heating system in order to form said rigid composite having at least one continuous surface that is smooth.

2. The method according to claim 1, wherein the mat of thermoplastic fibers is selected from the group consisting of polypropylenes, polyesters and co-polyesters, polyamides, polyethylene, polyvinyl chloride, polyphenylene sulfide, and fibers of core-sheath construction.

3. The method according to claim 1, wherein the mat of thermoplastic fibers has a basis weight ranging from 30 to 1000 grams per square meter.

4. The method according to claim 1, wherein the thermoplastic fiber comprise colored pigments.

5. The method according to claim 1, wherein the thermoplastic fiber comprise anti-UV agents.

6. The method according to claim 1, wherein the mat of thermoplastic fiber is bound to the substrate by needle punching.

7. The method according to claim 1, wherein the other fiber of the substrate also comprise thermoplastic fiber.

8. The method according to claim 7, wherein the other thermoplastic fibers of the substrate are selected from the group consisting of polypropylenes, polyesters and co-polyesters, polyamides, polyethylene polyvinyl chloride, polyphenylene sulfide, and fibers of core-sheath construction.

9. The method according to claim 7, wherein the non thermo-fusible fibers of the substrate are selected from the group consisting of glass, aramid, polyamide and carbon.

10. The method according to claim 1, wherein the substrate comprises thermosetting components selected from the group consisting of polyvinyl ester, phenol resins, unsaturated polyesters and epoxy.

11. The method according to claim 1, wherein the substrate is selected from the group consisting of conventional woven fabrics, knitted fabrics, groups of interlaced fibers and assemblies of non-interlaced continuous threads.

12. The method according to claim 1, wherein the method is carried out by a device for heating the multilayered structure, a device for compressing the multilayered structure comprising a smooth surface in contact with the mat of thermoplastic fibers, and a device for cooling the composite on which the mat of thermoplastic fibers has been melted under pressure.

13. The method according to claim 12, wherein the device for compressing the multilayered structure is a continuous press that working in a continuous or discontinuous way, a thermoforming press or a vacuum molding system each having said smooth surface intended to be in contact with the mat of thermo-fusible fibers.

14. A rigid composite material having a planar or curved structure, whenever obtained by the method according to claim 1.
